(19) United States
(12) Patent Application Publication
(10) Pub. No.: US 2013/0062448 A1
(43) Pub. Date: Mar. 14, 2013

(54) KITCHEN APPLIANCE HAVING A STORAGE DEVICE

(71) Applicants: Tobias Krüger, Munchen (DE); Karline Wichert, Munchen (DE)

(72) Inventors: Tobias Krüger, Munchen (DE); Karline Wichert, Munchen (DE)

(73) Assignee: BSH BOSCH UND SIEMENS HAUSGERATE GMBH, Munich (DE)

(21) Appl. No.: 13/699,373

(22) PCT Filed: May 10, 2011
(86) PCT No.: PCT/EP2011/057485

§ 371 Date: Nov. 21, 2012

(30) Foreign Application Priority Data
May 28, 2010 (DE) 10 2010 021 916.9

(51) Int. Cl. A47J 43/07

(52) U.S. Cl. 241/101.2

(57) ABSTRACT

An electric motor-driven kitchen appliance includes at least one coupling site for a plurality of tools for processing foodstuffs, and a storage facility which is made of a flexible material for storing the plurality of tools. The use of a flexible material for the storage facility simplifies handling because the storage facility is relatively light and easy to clean. Because of the flexible material, various tools can be used for storage because the storage facility can adapt flexibly to the outer shape of the tools. When the storage facility holds no tools or only a small number of tools, it can easily be pressed or folded together, which also leads to a space-saving storage of the storage device itself.

### BACKGROUND OF THE INVENTION

The present invention relates to an electric motor-driven kitchen appliance, in particular a food processor, having at least one coupling point for a plurality of tools for processing foodstuffs.

### PRIOR ART

Food processors or universal food processors are generally electrical kitchen appliances which are used in the known manner to knead, mix, grate, puree or juice. Such appliances consist of a base unit with a mixing bowl or collector and different attachments, for example choppers, blender attachments, grinders or citrus presses as well as various inserts or processing tools (cutting and grating disks, dough hooks, whisks and beaters). To carry out these abovementioned functions, food processors have a plurality of processing tools. The processing tools can be in the form of disks, drums or cones. Some appliances can be fitted with individual dough hooks or whisks. Mixing bowls or collectors are integrated in the appliance or can be detached; some of their tools are incorporated in a fixed manner. Some auxiliary appliances are complete units (mincer, citrus press), which only use the drive system of the processor. The speed of electrical appliances can generally be regulated in a number of stages or is continuously regulatable. To attach the processing tools, food processors have at least one interface or coupling point, which is set up to connect tools to the electrical drive system.

The tools of the kitchen appliance are generally stored separately or the appliance has a drawer or a compartment disposed in the housing. The drawers generally contain sharp tools such as chopping blades, shredding and grating inserts, etc.

It is also known for the accessories of the kitchen appliance to be able to be accommodated in a housing, which is covered by a lid. The lid is attached to the housing with the aid of hinges, so that a user can have access to the accessories. Such an apparatus is disclosed in U.S. Pat. No. 4,733,827. DE 600 08 405 T2 demonstrates a holder for storing accessories of a household appliance. The holder is configured as a unit on which the household appliance is positioned.

However the known solutions have various disadvantages. For example the drawer can develop defects or be destroyed due to frequent use, requiring the purchase of a new kitchen appliance. Also the production of such kitchen appliances requires a large number of production steps, which can also prove uneconomical.

### OBJECT OF THE INVENTION

The object of the invention is to provide an improved kitchen appliance compared with the prior art, which demonstrates flexible and wear-resistant storage of processing tools for the kitchen appliance.

### INVENTIVE SOLUTION

The cited object is achieved by a kitchen appliance having the features of claim 1. It provides an electric motor-driven kitchen appliance, in particular a food processor, having at least one coupling point for a plurality of tools for processing foodstuffs. The kitchen appliance has a storage facility made from a flexible material for the plurality of tools. The use of a flexible material for the storage facility allows ease of handling for a user, as the storage facility is relatively light and easy to clean. The flexible material means that different tools can be stored, as the storage facility can be flexibly tailored to the outer shape of the tools. If the storage facility holds no tools or only a small number of tools, it can be easily compressed or folded up, which also allows space-saving storage of the storage facility itself.

### PREFERRED EMBODIMENT OF THE INVENTION

Advantageous embodiments and developments, which can be used individually or in combination, are the subject matter of the dependent claims.

The flexible material is preferably a textile material. Textile materials are simple to process and also offer sufficient strength when used for a storage facility according to the present invention.

The kitchen appliance preferably comprises a processing bowl to hold foodstuffs to be processed, the storage facility being configured in such a manner that it can be stored in the processing bowl. This ensures space-saving storage of the storage facility in the processing bowl. The flexible material used for the storage facility can prevent the bowl being scratched by the generally sharp tools.

According to the invention the storage facility preferably has a cylindrical shape with a round, in particular circular, base surface and a lateral surface. The cylindrical shape is simple to produce and the storage facility can be easily compressed or folded up, allowing space-saving storage. Processing bowls also generally have a cylinder-like shape so the storage facility can easily be stored inside the processing bowl.

According to one embodiment of the present invention a height of the lateral surface is shorter than or equal to the bowl height of the processing bowl. This has the advantage that the storage facility can be stored in its entirety in the bowl. If the processing bowl also has a lid, this can also be put in place when the storage facility is inside the bowl. The tool can therefore always be stored in the bowl in a space-saving manner or, if the tool is in use, the storage facility itself can be stored in the processing bowl.

Expediently the base surface corresponds essentially to a bottom surface of the processing bowl. This allows the storage facility to be introduced in its entirety into the processing bowl.

The storage facility advantageously has at least one closable compartment for tools. If a number of compartments are created, they can for example hold different processing tools.

The at least one compartment can expediently be closed by means of a zipper.

The storage facility preferably has a carrying means. The carrying means make the storage facility easier to handle, particularly if it contains all the tools and can therefore be relatively heavy.

The present invention is particularly suitable for food processors, which have a plurality of coupling points for processing tools or tools. The processing tools can be stored in a space-saving manner and without causing injury in the storage facility, which in turn is easy to handle and stow, in other words store, due to the flexible material from which it is made.

### BRIEF DESCRIPTION OF THE DRAWINGS

Further advantageous embodiments are described in more detail below with reference to an exemplary embodiment illustrated in the drawing, to which however the invention is not restricted.

In the drawing:

FIG. 1 shows an electric motor-driven kitchen appliance;

FIG. 2 shows a processing bowl of the kitchen appliance with a storage facility;

FIG. 3 shows a plan view of the storage facility;

FIG. 4 shows a side view of the storage facility;

FIG. 5 shows a storage facility of the kitchen appliance with tools; and finally

FIG. 6 shows a closed storage facility according to the invention.

### DETAILED DESCRIPTION OF THE FIGURES

In the description which follows of preferred embodiments of the present invention, identical reference characters denote identical or comparable components.

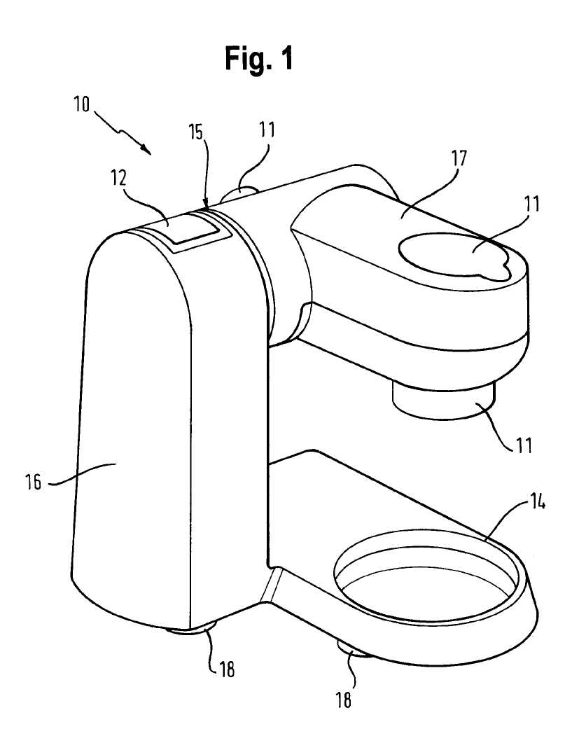

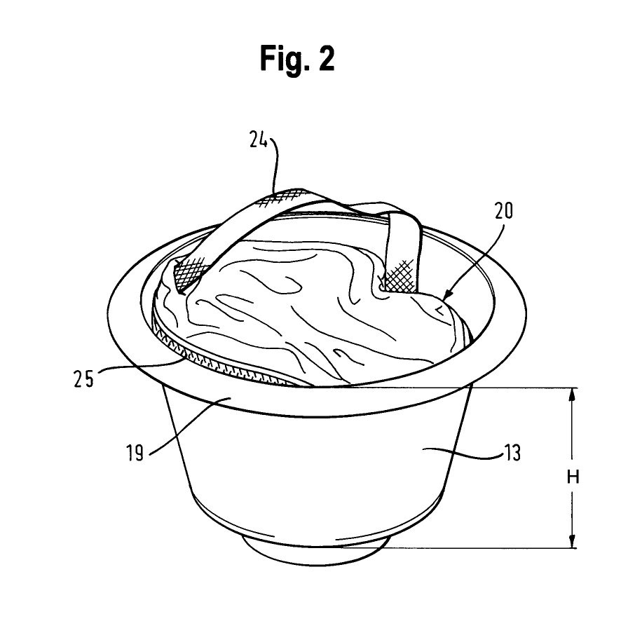

FIG. 1 shows a kitchen appliance, in particular an electric motor-driven kitchen appliance 10, preferably an electric motor-driven independent or universal food processor according to the present invention. The kitchen appliance 10 essentially has an L-shaped structure with a base part 14, on which a bowl 13 can be positioned to hold foodstuffs. The kitchen appliance 10 comprises a base unit 16 and a pivot arm 17. According to this embodiment of the present invention the pivot arm 17 has a plurality of coupling points 11 for processing tools 22. Processing tools 22 here refer in particular to pureeing, mixing, chopping, kneading and/or cutting tools, beaters and whisks, beverage mixers, slicers, grinders, citrus and fruit presses and/or mincers. Individual coupling points 11 can be operated as a function of the pivot arm position, the drive motor of the electrical kitchen appliance 10 generally being disposed in the base unit 16 and its torque being transmitted to the individual coupling points 11 by way of suitable transmission facilities. Thus the coupling point 11 in the lower region, with reference to FIG. 1, of the pivot arm 17 is used for example to operate a mixing tool 22 for processing pastry. The coupling point 11 disposed on the side of the pivot arm 17 can be used to attach a mincer, it being also possible to use other processing tools 22.

The pivot arm 17 interacts with the base unit 16 of the kitchen appliance 10 at a bearing point 15. The bearing point 15 is configured such that the pivot arm can take up different operating positions. FIG. 1 shows a first operating position I, in which the pivot arm 11 is fixed horizontally in order for example to be able to process pastry in a mixing bowl 13 disposed on the base part 14 below the coupling point 11.

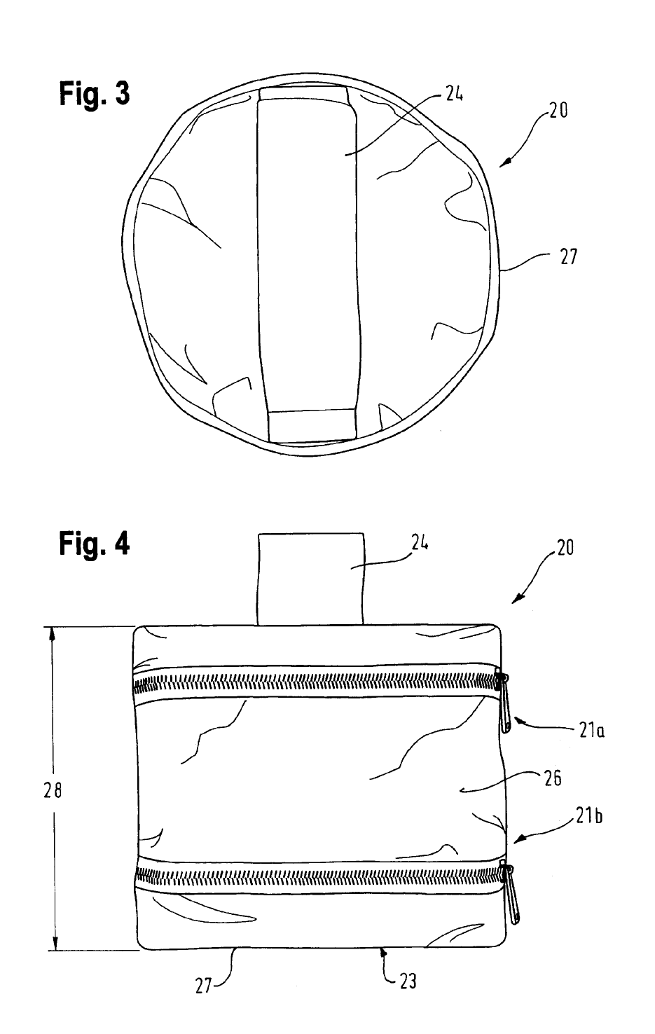

FIG. 3 shows a processing bowl 13, in which a storage facility 20 according to the present invention is stored or disposed. The height of the bowl 14 is illustrated schematically, being shown from the base of the bowl 13 to its upper edge 19 (circumferential bowl edge 19). The bowl height 14 essentially corresponds to the height 21 of the storage facility 20, so that the storage facility 20 itself can be stored in its entirety in the bowl 13. The flexible material, in particular textile material or textile, of the storage facility 20 means that the bowl 13 is not scratched.

A textile material is a flexible material consisting of a network of fibers. Fibers, yarn, textile surfaces such as woven, knitted or crocheted fabrics and manufactured products (including clothing or bags) are all covered by the term textiles or textile materials.

The storage facility also has a carrying means 24 in the form of a loop, which makes it easier for a user to handle the storage facility 20.

FIG. 3 shows a schematic plan view of a storage facility according to the present invention. According to this embodiment the storage facility 20 is cylindrical with a circular base surface 23. The cylindrical shape means that the storage facility 20 has an upper and lower circumferential edge 27, which forms a reinforced rim of the flexible material or textile material. The edge 27 ensures that the storage facility 20 has a stable structure and is provided by a seam or by means of a bonding process. This reinforced circumferential edge 27 means that the storage facility 20 essentially has a circular surface as its base surface 23, so that the storage facility 20 itself can be stored in an optimum manner in the bowl 13. The bowl also has a circular surface as its base surface.

The carrying means 24 in the form of a handle can likewise be made of a textile material or another flexible material and is disposed diametrically on the base surface of the storage facility 20. It is however possible for a plurality of carrying means 24 to be disposed on the base surface 23 and/or on the lateral surface 26 of the storage facility.

FIG. 4 shows the schematic side view of the storage facility corresponding to the plan view in FIG. 3. As mentioned above, the storage facility according to this embodiment has a cylindrical shape with a lateral surface 26 and a height 28. The height 28 of the storage facility 28 is essentially tailored to the bowl height 14, so that the storage facility 20 itself can be positioned or stored in its entirety in the processing bowl.

The storage facility 20 has two compartments 21a and 21b for processing tools 22, each being able to be closed by means of a zipper 25. The flexible material of the storage facility 20 means that it can easily be compressed, allowing space-saving storage. For example a user can press the surface with the carrying means 24 toward the base surface 23, so that the storage facility 20 has a reduced height 28. This has the advantage that the storage facility 20 itself can also be stored in smaller processing bowls 13 than originally planned. The lateral surface 26 is configured so that when a user compresses the storage facility 20, folds are formed, running in the direction of the interior of the cylindrical shape. In the compressed or folded state the outer contour of the storage facility 20 therefore always remains within the edge 27 of the base surface 23, so that it can still be positioned in the processing bowl 13.

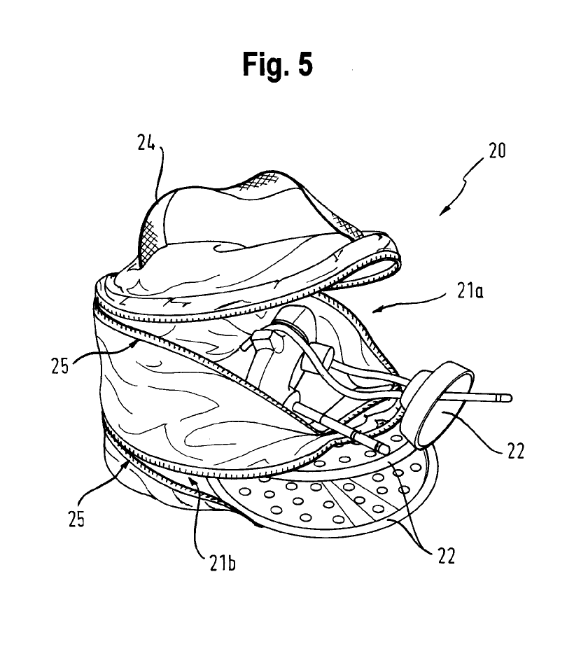

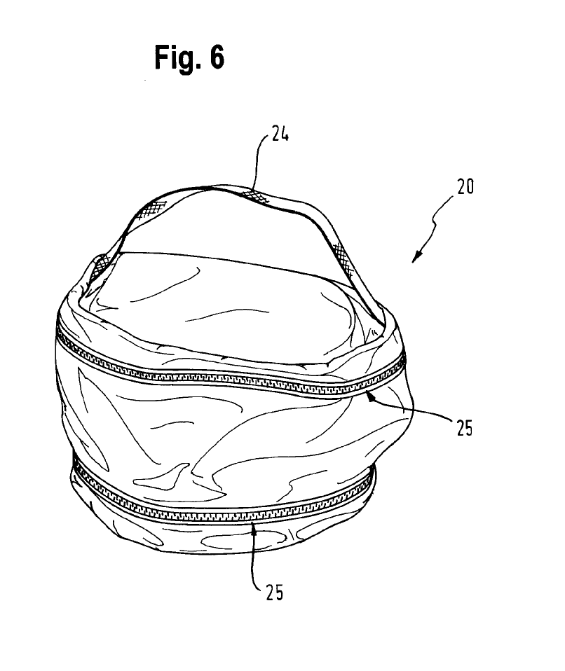

FIG. 5 shows the storage facility according to the present invention with two compartments 21a and 21b, in which different tools or accessories of the kitchen appliance 22 are stored. According to this arrangement disk-type tools 22 are in the lower compartment 21b and the upper compartment 21b correspondingly holds a whisk and/or dough hook 22. FIG. 6 shows the storage facility 20 from FIG. 5 with the zippers 25 closed.

A kitchen appliance having a storage facility according to the present invention ensures simple and space-saving storage of tools and/or accessories of the kitchen appliance. The flexible material used for the storage facility means that it is light and can be handled easily. Simplified and economical production of the storage facility is a further advantage.

### LIST OF REFERENCE CHARACTERS

10 Kitchen appliance, in particular food processor
11 Coupling points
12 Operating part for swivel arm
13 Processing bowl
14 Bowl height
15 Bearing point
16 Base unit
17 Pivot arm
18 Feet
19 Bowl edge
20 Storage facility
21a, 21b Compartments for tools and accessories
22 Tools
23 Base surface of storage facility
24 Carrying means or handle
25 Zipper
26 Lateral surface
27 Edge
28 Height of lateral surface

1-9. (canceled)

10. An electric motor-driven kitchen appliance, comprising:
at least one coupling point for a plurality of tools for processing foodstuffs; and
a storage facility made from a flexible material for storage of the plurality of tools.

11. The electric motor-driven kitchen appliance of claim 10, constructed in the form of a food processor.

12. The electric motor-driven kitchen appliance of claim 10, wherein the flexible material is a textile material.

13. The electric motor-driven kitchen appliance of claim 10, further comprising a processing bowl for holding foodstuffs to be processed, the storage facility being configured for placement in the processing bowl.

14. The electric motor-driven kitchen appliance of claim 10, wherein the storage facility is configured of cylindrical shape with a round base surface and a lateral surface.

15. The electric motor-driven kitchen appliance of claim 14, wherein the base surface is circular.

16. The electric motor-driven kitchen appliance of claim 13, wherein the storage facility is configured of cylindrical shape with a round base surface and a lateral surface, the lateral surface having a height which is shorter than or equal to a bowl height of the processing bowl.

17. The electric motor-driven kitchen appliance of claim 13, wherein the storage facility is configured of cylindrical shape with a round base surface and a lateral surface, the base surface corresponding essentially to a bottom surface of the processing bowl.

18. The electric motor-driven kitchen appliance of claim 10, wherein the storage facility has at least one closable compartment for tools.

19. The electric motor-driven kitchen appliance of claim 18, wherein the storage facility has a zipper for closing the at least one compartment.

20. The electric motor-driven kitchen appliance of claim 10, wherein the storage facility has a handle.
